(19) United States
(12) Patent Application Publication
(10) Pub. No.: US 2023/0195417 A1
(43) Pub. Date: Jun. 22, 2023

(54) PARALLEL COMPUTATION OF A LOGIC OPERATION, INCREMENT, AND DECREMENT OF ANY PORTION OF A SUM

(71) Applicant: Intel Corporation, Santa Clara, CA (US)

(72) Inventors: Mrinmay Dutta, Bangalore (IN); Simon Rubanovich, Haifa (IL); Amit Gradstein, Binyamina (IL); Zeev Sperber, Zichron Yackov (IL)

(73) Assignee: Intel Corporation, Santa Clara, CA (US)

(21) Appl. No.: 17/559,811

(22) Filed: Dec. 22, 2021

(51) Int. Cl. G06F 7/507; G06F 7/76; G06F 7/505; G06F 7/501

(52) U.S. Cl. CPC G06F 7/507; G06F 7/501; G06F 7/764; G06F 7/5057

(57) ABSTRACT

One embodiment provides a processor comprising at least one of a first mask to receive a first input operand and a second input operand and to generate a selected portion of an AND of a sum of the first input operand and the second input operand using an AND chain of the first mask in parallel with generation of the sum by an adder; and a second mask to receive the first input operand and the second input operand and to generate the selected portion of an OR of the sum using an OR chain of the second mask in parallel with generation of the sum.

### BACKGROUND

In digital design, it is often required to compute the addition of two operands and check some portion of the sum for a condition, such as whether the upper bits of the sum are all ones or all zeroes. While this sounds like a simple computation, there is a serial dependency between the performing the condition check and obtaining the result from the adder. Computation of the condition check must wait for computation of the sum to be finished, which results in slowness in the overall speed of the operation. A similar situation occurs for computing the addition of two operands and incrementing or decrementing the sum at an intermediate bit position.

Consider the situation where X[n:0] and Y[n:0] are two (n+1)-bit data operands and S[n:0] is their (n+1) bit sum, where n is a natural number. The above problem statement can be mathematically represented as: 1) &S[m:i] =1, where {n ≥ m ≥ i ≥ 0}, AND of Sum (an all 1 s check); 2)|S[m:i] =0, where {n ≥ m ≥ i ≥ 0}, OR of Sum (an all 0 s check); 3)S + 2^i, where {n ≥ i ≥ 0}, increment the sum S at an intermediate bit; and 4) S - 2^i, where {n ≥ i ≥ 0}, decrement the sum S at an intermediate bit. These computations have a serial dependency on computing the sum S, which results in poor performance. These computations are also frequently used in, for example, a limit check operation (| S[n:0] | ≤ 2^i), an over shift count indication of an alignment shift counter in a floating-point addition operation, a zero flag computation with a carry-in to the adder, rounding in floating-point computations, computing an absolute value of a sum or a difference, etc.

A fast parallel computation technique would improve the performance of such operations.

### BRIEF DESCRIPTION OF THE DRAWINGS

The present invention is illustrated by way of example and not limitation in the figures of the accompanying drawings in which like references indicate similar elements, and in which:

FIG. 1 illustrates a system that can be used for parallel computation of a logic operation, increment and/or decrement of any portion of a sum according to an embodiment;

FIG. 2 is a diagram of circuitry for parallel computation of a logic operation any portion of a sum according to an embodiment;

FIG. 3 is a flow diagram of processing for parallel computation of a logic operation of any portion of a sum according to an embodiment.

FIG. 4A is a block diagram illustrating both an exemplary in-order pipeline and an exemplary register renaming, out-of-order issue/execution pipeline according to some embodiments;

FIG. 4B is a block diagram illustrating both an exemplary embodiment of an in-order architecture core and an exemplary register renaming, out-of-order issue/execution architecture core to be included in a processor according to some embodiments;

FIGS. 5A-B illustrate a block diagram of a more specific exemplary in-order core architecture, which core would be one of several logic blocks (including other cores of the same type and/or different types) in a semiconductor chip;

FIG. 6 is a block diagram of a processor that may have more than one core, may have an integrated memory controller, and may have integrated graphics according to some embodiments;

FIGS. 7-10 are block diagrams of exemplary computer architectures according to some embodiments; and

FIG. 11 is a block diagram contrasting the use of a software instruction converter to convert binary instructions in a source instruction set to binary instructions in a target instruction set according to some embodiments.

### DETAILED DESCRIPTION

Embodiments discussed herein provide techniques and mechanisms for a circuit to perform parallel computation of a logical operation, increment and/or decrement of any portion of a sum with negligible extra hardware cost. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to perform parallel computation of a logical operation, increment and/or decrement of any portion of a sum within a processor or core.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

For the purposes of explanation, numerous specific details are set forth to provide a thorough understanding of the various embodiments described below. However, it will be apparent to a skilled practitioner in the art that the embodiments may be practiced without some of these specific details. In other instances, well-known structures and devices are shown in block diagram form to avoid obscuring the underlying principles, and to provide a more thorough understanding of embodiments. The techniques and teachings described herein may be applied to a device, system, or apparatus including various types of circuits or semiconductor devices, including general purpose processing devices or graphic processing devices. Reference herein to “one embodiment” or “an embodiment” indicate that a particular feature, structure, or characteristic described in connection or association with the embodiment can be included in at least one of such embodiments. However, the appearances of the phrase “in one embodiment” in various places in the specification do not necessarily all refer to the same embodiment.

Those skilled in the art will appreciate that a wide variety of devices may benefit from the foregoing embodiments. Exemplary core architectures, processors, and computer architectures are non-limiting examples of devices that may beneficially incorporate embodiments of the technology described herein. Other processors, devices, and/or systems may also be provided based on the description provided below.

As noted above, existing approaches for logical AND or OR checks of a portion of a sum are serial in nature. That is, the condition check waits for the addition operation to be completed, which is then typically followed by execution of an AND/OR chain. The AND/OR chain of existing approaches generally uses three-input AND/OR gates (or three-input NAND/NOR gates). Higher input AND/OR Gates can be used at a cost of more delay per stage and two-input AND/OR gates can be used at cost of more stage delay. The three input gates chain has been found to be optimal for overall delay for most cases. However, this costs log₃^{(m-i+1)} stages of three-input NAND/NOR to adder delay (where i and m are the indices of the bits for the portion of the sum). If the three-input NAND/NOR gate delay is Tn3, the total delay of this serial approach can be expressed as

$$T o t a l D e l a y = A d d e r D e l a y + T n 3 ∗ \left⌈l o {g}_{3} \left(m - i + 1\right)\right⌉$$

Existing operations to increment or decrement the sum at an intermediate bit ‘i’, called the ‘i^{th}_increment’ and ‘i^{th}_decrement’ herein, may be performed using serial or parallel computation. In a known serial approach, the adder is simply followed by (n-i + 1) wide increment/decrement logic. While the serial approach is efficient in terms of area and power, the serial approach is slower due to the increment/decrement delay. If the sum itself is not needed, then a 3:2 carry sum adder (CSA) with X[n:0], Y[n:0] and ±2^i can be used before the adder to perform the increment or decrement operation. In most cases, both values (e.g., the sum and the i bit) are needed or a choice between them is based on a “late” control signal (e.g., for rounding in a floating-point operation). Such an approach typically costs more than twice the hardware circuitry and incurs a 2*XOR delay (since the 3:2 CSA adds 2*XOR delays in the timing path) to operation of the adder.

The technology described herein provides for computation of a logic operation, increment, and/or decrement of any portion of a sum in parallel, with a minimal increase in hardware and less delay than existing approaches. The parallel solution of embodiments described herein improves the performance of these operations.

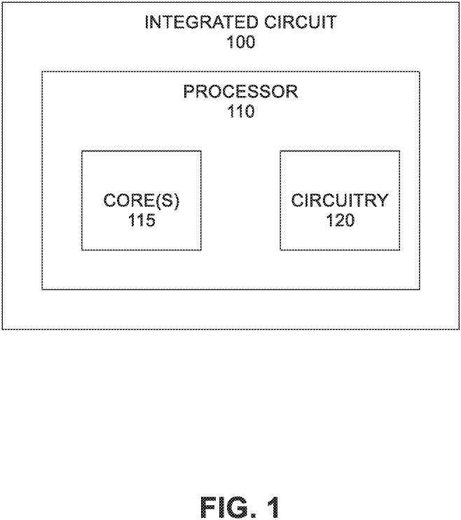

With reference to FIG. 1, an embodiment of an integrated circuit 100 may include a processor 110 with one or more cores 115 and circuitry 120 coupled to the one or more cores 115. The circuitry 120 may be configured to perform parallel computation of a logical operation, increment and/or decrement of any portion of a sum with negligible extra hardware cost.

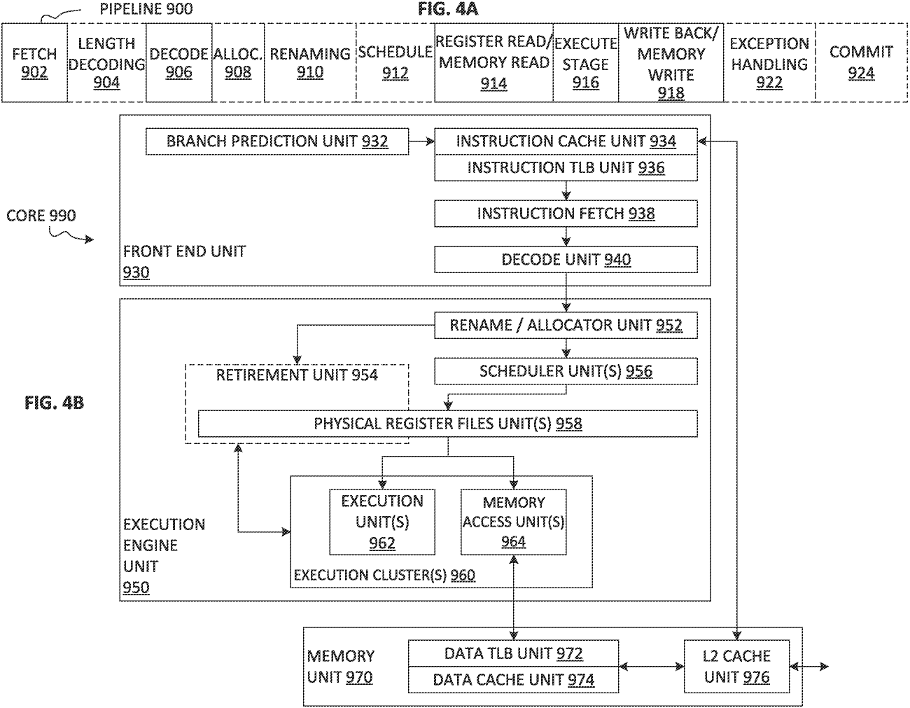

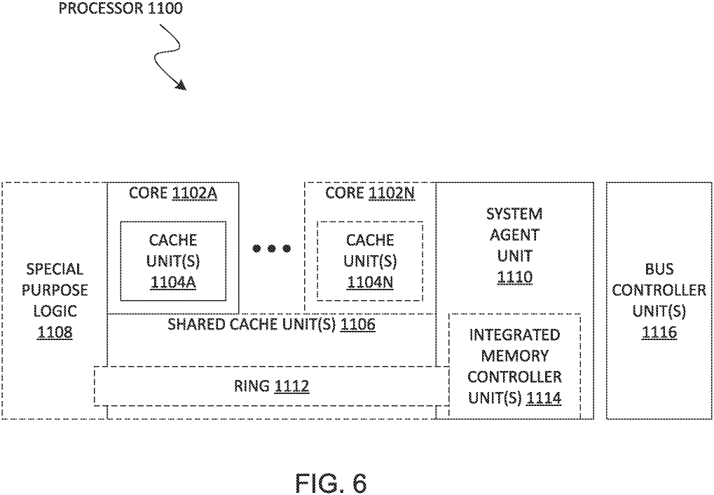

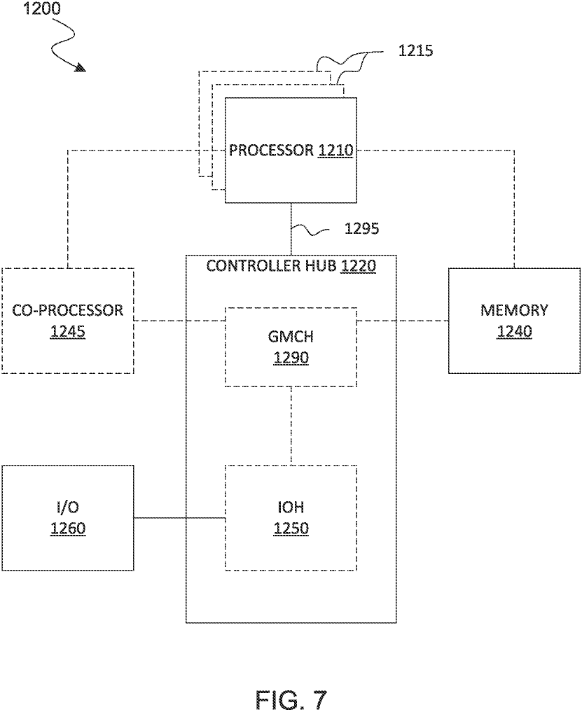

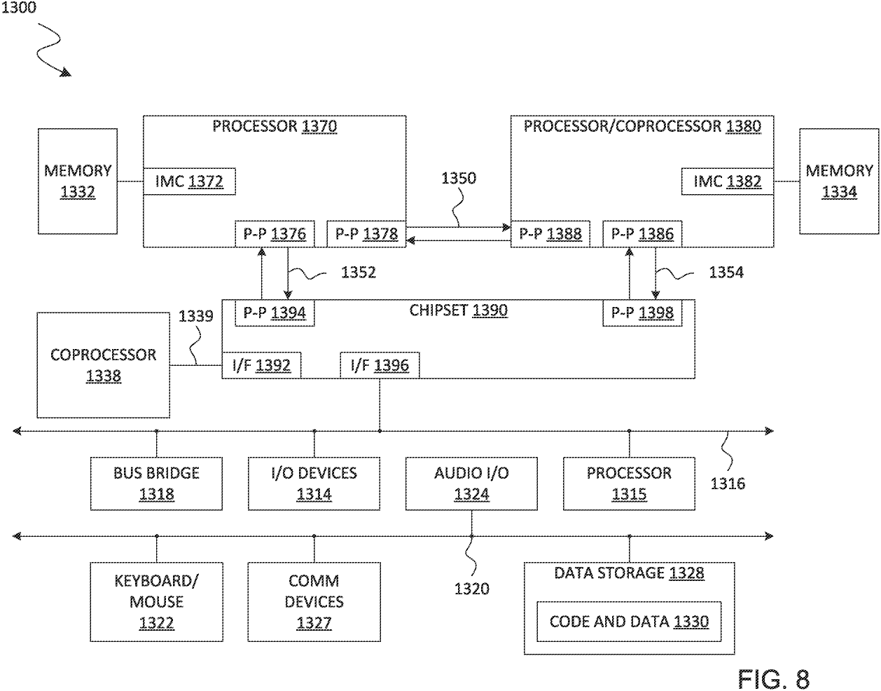

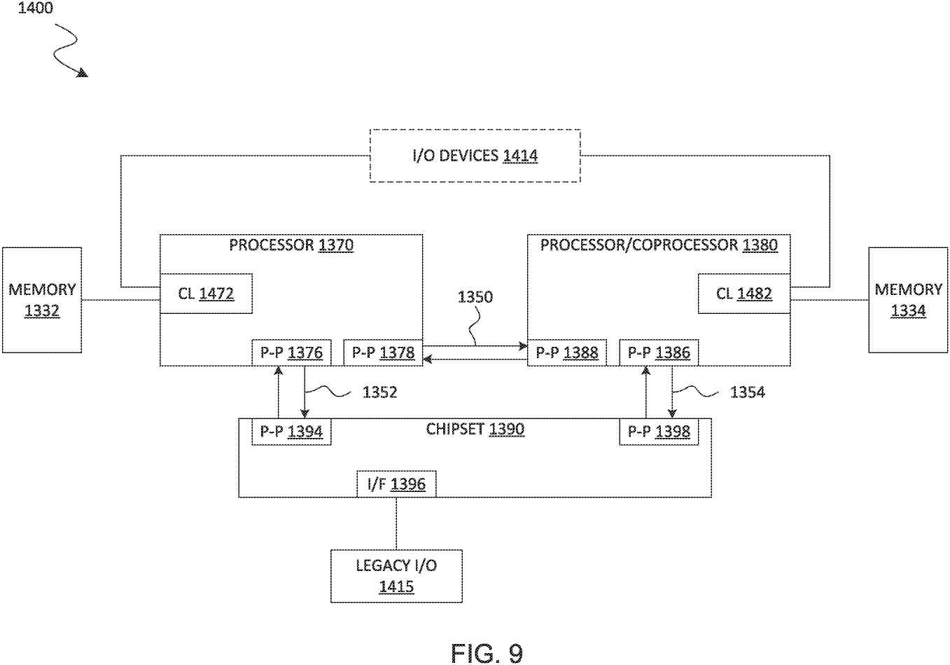

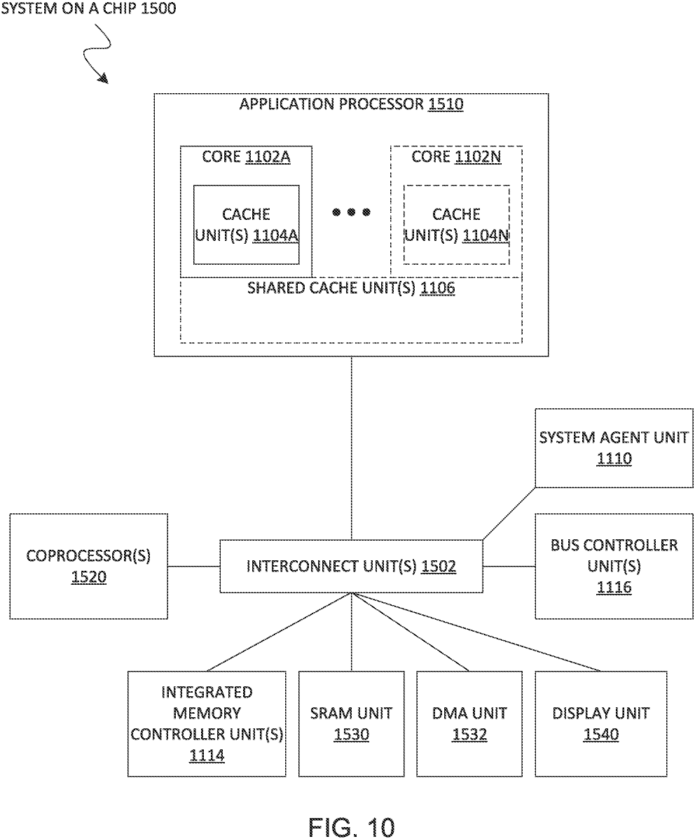

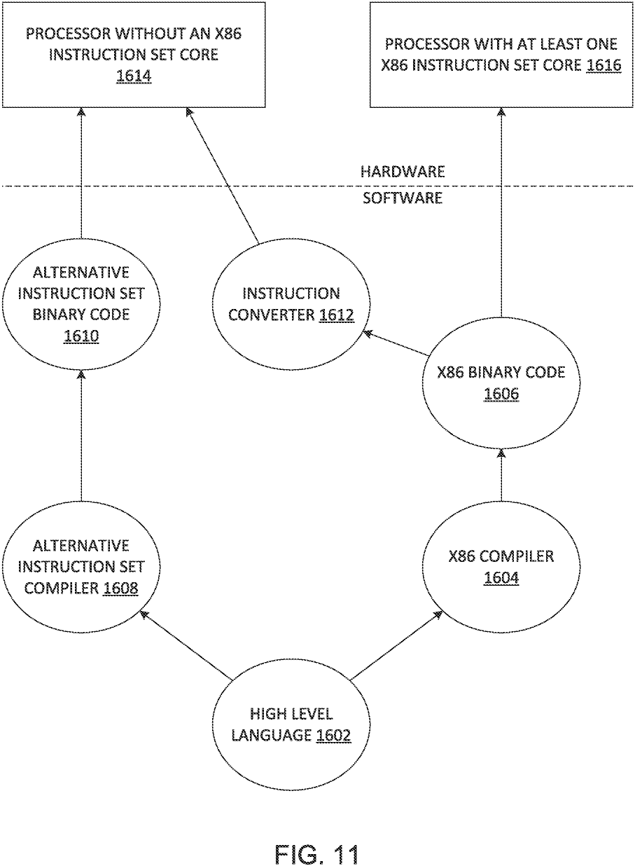

Embodiments of the circuitry 120 may be integrated with any suitable core such as those described herein including, for example, the core(s) 115, the core 990 (FIG. 4B) and/or the cores 1102A-N (FIGS. 6 and 10). Embodiments of the circuitry 120 may be incorporated in a processor such as those described herein including, for example, the processor 1100 (FIG. 6), the processor 1210 (FIG. 7), the co-processor 1245 (FIG. 7), the processor 1370 (FIGS. 8 and 9), the processor/coprocessor 1380 (FIGS. 8 and 9), the coprocessor 1338 (FIGS. 8 and 9), the application processor 1510 (FIG. 10), the coprocessor 1520 (FIG. 10), and/or the processors 1614, 1616 (FIG. 11). In some embodiments, the circuitry 120 may include the core’s circuitry that executes microcode to implement the functions of the circuitry 120.

Consider a first input operand X[n:0] and a second input operand Y[n:0] that are two ‘n+1’ bit data values to be added or subtracted to produce a result sum S[n:0]:

$$S u m = {\left\{S \left[k\right]\right\}}_{k = 0}^{n} = X \left[n : 0\right] + Y \left[n : 0\right]$$

Table 1 shows the addition or subtraction of the two n+1 data values.

TABLE 1

| | | | | | | | | | | | | |
|---|---|---|---|---|---|---|---|---|---|---|---|---|
| | n | . | . | m | . | k | . | i | . | . | 1 | 0 |
| X[n:0] | X[n] | | | X[m] | | X[k] | | X[i] | | | X[1] | X[0] |
| Y[n:0] | Y[n] | | | Y[m] | | Y[k] | | Y[i] | | | Y[1] | Y[0] |
| S[n:0] | S[n] | . | . | S[m] | . | S[k] | . | S[i] | . | . | S[1] | S[0] |

Let ‘m’, ‘k’ and ‘i’ denote indices in the sum S where n ≥ m ≥ k ≥ i ≥ 0. Propagation (P), Generation (G), Zero (Z) and Carry (C) of an adder at the k bit position can be expressed as:

$$G \left[k\right] = X \left[k\right] \& Y \left[k\right]$$

$$P \left[k\right] = X \left[k\right] ⊕ Y \left[k\right]$$

$$Z \left[k\right] = \sim \left(X \left[k\right] \vert Y \left[k\right]\right) = \sim \left(G \left[k\right] \vert P \left[k\right]\right)$$

$$C \left[k\right] = G \left[k - 1\right] \vert \left(P \left[k - 1\right] \& C \left[k - 1\right]\right)$$

The sum S at bit k is:

$$S \left[k\right] = X \left[k\right] ⊕ Y \left[k\right] ⊕ C \left[k\right] = P \left[k\right] ⊕ C \left[k\right]$$

The carry is:

$$C o u t = C \left[n + 1\right] = G \left[n\right] \vert \left(P \left[n\right] \& C \left[n\right]\right)$$

An embodiment introduces a first mask, called an O Mask, and a second mask, called a Z Mask, defined as follows:

$$O M a s k \left[k\right] {=}^{\text{def}} P \left[k\right] ⊕ G \left[k - 1\right] f \text{} o r \text{n} \geq \text{k} > i$$

$$Z M a s k \left[k\right] {=}^{\text{def}} P \left[k\right] ⊙ Z \left[k - 1\right] f \text{} o r \text{n} \geq \text{k} > i$$

where G[k] is generation, P[k] is propagation and Z[k] is zero of an adder at bit position ‘k’ which is computed from the input X[n:0] and Y[n:0].

In embodiments, the O Mask may be used in place of the sum S to compute the ‘AND of Sum’ (i.e., &S[m:i]).

$$\& S \left[m : i\right] = \& O M a s k \left[m : \left(i + 1\right)\right] \& S \left[i\right]$$

This equation can be further simplified using the Shannon Expansion Theorem on S[i] for better timing.

$$\begin{matrix}\& S \left[m : i\right] = C \left[i\right] ? \left(\& O M a s k \left[m : \left(i + 1\right)\right] \& \sim P \left[i\right]\right) : \\ \left(\& O M a s k \left[m : \left(i + 1\right)\right] \& P \left[i\right]\right)\end{matrix}$$

The AND chain of the O Mask may be done in parallel with a carry chain of the adder at a lesser delay than the carry chain, which enables computation of &S[m:i] at one XOR2 delay from carry C[i]. Depending on bit ‘i’, this is the same or less delay than computing sum S.

In an embodiment, the O mask may be generated directly from X and Y as:

$$O M a s k \left[k\right] = X \left[k\right] ⊕ Y \left[k\right] ⊕ \left(X \left[k - 1\right] \& Y \left[k - 1\right]\right)$$

(from input operands X and Y)

The Z Mask may be used in place of the sum S to compute the ‘OR of Sum’ (i.e., |S[m:i]).

$$\vert S \left[m : i\right] = \vert Z M a s k \left[m : \left(i + 1\right)\right] \vert S \left[i\right]$$

$$\vert S \left[m : i\right] = C \left[i\right] ? \left(\vert Z M a s k \left[m : \left(i + 1\right)\right] \vert \sim P \left[i\right] \text{}\right) : \left(\vert Z M a s k \left[m : \left(i + 1\right)\right] \vert P \left[i\right]\right)$$

The OR chain of Z Mask can be done in parallel with the carry chain of the adder at a lesser delay than the carry chain, which enables computation of |S[m:i] at one XOR2 delay from carry C[i]. Depending on bit ‘i’, this is the same or less delay than computing sum S.

In an embodiment, the Z mask may be generated directly from X and Y as:

$$Z M a s k \left[k\right] = X \left[k\right] ⊕ Y \left[k\right] ⊕ \left(X \left[k - 1\right] \vert Y \left[k - 1\right]\right)$$

(from input operands X and Y)

The i^{th}_Increment of sum S_{inc} [n: i] can be expressed as below:

$${S}_{i n c} \left[i\right] = \sim S \left[i\right]$$

$$\begin{matrix}{S}_{i n c} \left[m\right] = S \left[m\right] ⊕ {C}_{i n c} \left[m\right] \text{for ′n} \geq \text{m > i′} \\ \text{where:} {C}_{i n c} \left[m\right] = \& S \left[m : i\right]\end{matrix}$$

The carry of increment at any bit ‘m’ is AND of Sum at the ‘m’ bit, which may be computed in parallel to carry chain as explained above.

The i^{th}_Decrement of sum S_{dec} [n: i]′ can be expressed as below:

$${S}_{d e c} \left[i\right] = \sim S \left[i\right]$$

$${S}_{d e c} \left[m\right] = S \left[m\right] ⊕ {C}_{d e c} \left[m\right] \text{for ′n} \geq \text{k > i′}$$

$$\text{Where:} {C}_{d e c} \left[m\right] = \vert S \left[m : i\right]$$

The carry of decrement at any bit ‘m’ is OR of Sum at the ‘m’ bit, which may be computed in parallel to carry chain as explained above.

In summary, embodiments include two masks O Mask and Z Mask, which may be computed either directly from input data based on the above definition or from input data forwarded from propagation and generation circuitry of an adder by sharing hardware. In both cases, the worst-case delay is the same 2*(XOR2 Delay) from input. The O Mask may be used to compute AND of Sum in parallel with the sum computation (unlike the existing solution where computation of AND of Sum must wait for the computation of the Sum and hence has a serial dependency). The Z Mask may be used to compute OR of Sum in parallel with the sum computation, eliminating the serial dependency between computation of the sum and OR of Sum. Since the AND chain and the OR chain are faster than the carry chain, this makes AND of O Mask and OR of Z Mask compute faster than the carry chain. This makes AND of Sum and OR of Sum compute at the same time or faster than sum depending on the bit position.

The i^{th}_Increment and the i^{th}_Decrement can use AND of Sum and OR of Sum at all bit positions starting from ‘i’ to generate increment and decrement carry. This enables parallel computation of these increments and decrements in parallel with computation of the adder sum.

Parallel computation enables fast design of circuitry for computation of the AND of the sum and/or the OR of the sum. These values are computed earlier than waiting for the adder to compute the sum, and at worst case, at the same time as the adder computing the sum. Unlike other parallel approaches, the technology described herein uses minimal hardware growth: one XOR gate per (i.e., m-i+1 XOR gates per bit, one 2:1 mux and two AND gates for Shannon Expansion (the AND gates for the AND chain are required anyway for existing serial mode of computation). The same is true for the Sum OR case. Embodiments produce i^{th}_increment and i^{th}_decrement output values at a single XOR delay added to the adder output delay, which is faster by at least one XOR delay than existing parallel approaches. In sum, embodiments represent a faster circuit but using the same area and power of a slower serial design.

The technology described here may be used to reduce the latency of fused multiply-add (FMA), Fast Adder, and floating point (FP) 16/BF16 to FP32 dot product operations to help a serial chain of floating-point operations execute faster and improve instructions per cycle (IPC). These latency reductions also may improve utilization of floating-point units by reducing a number of general-purpose register (GPRs) required by an accumulator, which in turn improves the throughput of the processor.

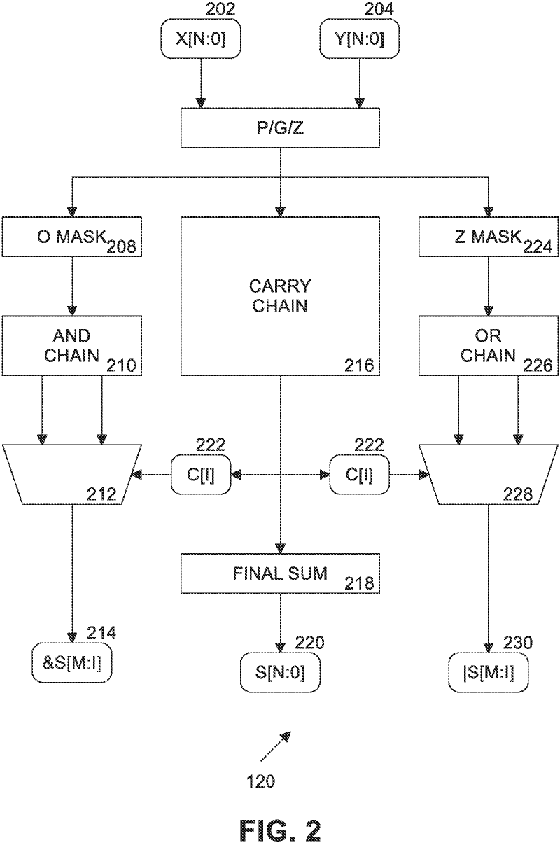

FIG. 2 is a diagram of circuitry 120 for parallel computation of a logic operation, increment and/or decrement of any portion of a sum according to an embodiment. The first input operand denoted X [n:0] 202 and the second input operand denoted Y [n:0] 204, each having n+1 bits, n being a natural number, are input to propagation and generation (P/G/Z) 206. In an embodiment, P/G/Z 206 computes Propagation (P, using equation 1) and Generation (G, using equation 2) required for the adder computation. O Mask 208 unit takes this P and G and computes the O mask (using equation 3). Z mask 224 takes P and Z and computes the Z mask (using equation 4).

In another embodiment, the first and second input operands are forwarded directly and input to the O mask 208 without using P/G/Z 206. The O mask 208 is used in place of sequentially computing the AND′ing of the i through m bits of the sum. The O Mask 208 output value is input to AND chain 210. The output of AND chain 210 is input to first multiplexer 212. The i carry bit 222 of the output from carry chain 216 is also input to first multiplexer 212.

$$\& S [ m : i ] = C [ i ] ? ( \& O M a s k [ m : ( i + 1 ) ] \& \sim P [ i ] ) : ( \& O M a s k [ m : ( i + 1 ) ] \& P [ i ] )$$

The output of first multiplexer 212 is the AND′ing of the i through the m bits of the sum (&S[m, i] 214).

Propagation and zero (P/G/Z) 206 generates a second mask, called the Z mask 224. In another embodiment, the first and second input operands are forwarded directly and input to the Z mask 224 without using P/G/Z 206. The Z mask 224 is used in place of sequentially computing the ORing of the i through m bits of the sum. The Z Mask 224 output value is input to OR chain 226. The output of OR chain 226 is input to second multiplexer 228. The i carry bit 222 of output from carry chain 216 is also input to second multiplexer 228.

$$\begin{matrix}\left|S \left[m : i\right] = C \left[i\right]\right) ? \left(\left|Z M a s k \left[m : \left(i + 1\right)\right]\right) \left|\sim P \left[i\right]\right)\right) : \\ \left(\left|Z M a s k \left[m : \left(i + 1\right)\right]\right) \left|P \left[i\right]\right)\right)\end{matrix}$$

The output of second multiplexer 228 is the ORing of the i through the m bits of the sum (|S[m,i] 230). Final sum 218 generates the sum 220 (S[n, 0]), but independently and in parallel with generation of &S[m, i] 214 and |S[m,i] 230.

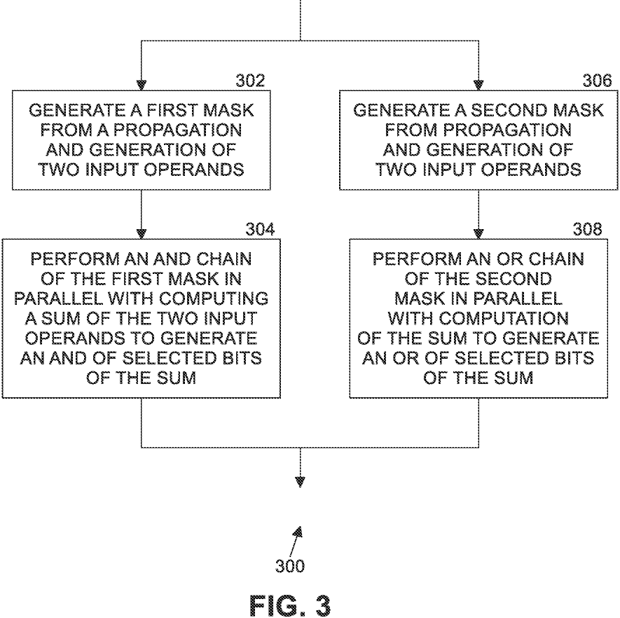

FIG. 3 is a flow diagram of processing 300 for parallel computation of a logic operation any portion of a sum according to an embodiment. Embodiments of the processing 300 may be performed by a processor such as those described herein including, for example, the processor 1100 (FIG. 6), the processor 1210 (FIG. 7), the co-processor 1245 (FIG. 7), the processor 1370 (FIGS. 8-9), the processor/coprocessor 1380 (FIGS. 8-9), the coprocessor 1338 (FIGS. 8-9), the application processor 1510 (FIG. 10), the coprocessor 1520 (FIG. 10), and/or the processors 1614, 1616 (FIG. 11). For example, the method 300 may be performed by the execution of suitable microcode by the core/processor.

In an embodiment, only blocks 302 and 304 are performed. In another embodiment, only blocks 306 and 308 are performed. In a further embodiment, blocks 302 and 304, and blocks 306 and 308, may both be performed in parallel. At block 302, circuitry 120 generates a first mask (e.g., the O mask 208) from P/G/Z 206 forwarding of two input operands 202, 204. In another embodiment, the first mask receives the two input operands directly without using P/G/Z 206. At block 304, circuitry 120 generates a second mask (e.g., the Z mask 224) from the propagation and zero P/G/Z 206 of the two input operands 202, 204. In another embodiment, the second mask receives the two input operands directly without using P/G/Z 206. At block 306, circuitry 120 performs an AND chain 210 of the first mask 208 in parallel with computing (e.g., using carry chain 216) a sum 220 of the two input operands 202, 204 to generate an AND of selected bits (e.g., &S[m:i]) of the sum 220. At block 308, circuitry 120 performs an OR chain 226 of the second mask 224 in parallel with computation (e.g., using carry chain 216) of the sum 220 to generate an OR of selected bits (e.g., |S[m:i]) of the sum.

Mathematical proof: Using 0 Mask in place of computation of the AND of the sum. Theorem: S[k] = 1 for all k in the interval n ≥ k ≥ i, if and only if 0 Mask[k] = 1 in the interval n ≥ k > i and S[i] = 1. Proof: Suppose S[k] = 1 for all k in the interval n ≥ k ≥ i, but 0 Mask[m] = 0 for an index m in the interval n ≥ m > i. Now 0 Mask[m] = 0 implies P[m] is equal to G[m-1]. If P[m] then G[m-1] makes S[m] = 0. If ~P[m] then ~G[m-1] . Z[m-1] makes S[m]=0, while P[m-1] makes either S[m-1] =0 (if there is carry) or S[m]=0 (if there isn’t carry). So, we have 0 Mask[m] = 1.

Now show the opposite proof. Suppose that 0 Mask[k] = 1 for n ≥ k > i but S[m] = 0 for an index m in interval n ≥ m > i. Suppose m is lowest bit index for which S[m] = 0, i.e. S[k] = 1 for all k in interval m > k ≥ i. 0 Mask[m] = 1 implies P[m] is opposite to G[m-1]. If P[m] then Z[m-1] is impossible because then S[m]=1. P[m-1] is impossible because then S[m-1] =0 to make S[m] = 0. So, we have G[m-1]. If ~P[m] then G[m-1] is impossible because then S[m]=1. So, we have 0 Mask[m] = 0. It is sufficient to compute &0 Mask[m: (i + 1)] & S[i] to get the AND of the sum (i.e. &S[m:i]).

$$\& \text{S} \left[\text{m:i}\right] = \& \text{O Mask} \left[\text{m:} \left(\text{i} + 1\right)\right] \& \text{S} \left[\text{i}\right]$$

$$\begin{matrix}\& \text{S} \left[\text{m:i}\right] = \text{C} \left[\text{i}\right] ? \left(\& \text{O Mask} \left[\text{m:} \left(\text{i} + 1\right)\right] \& \text{\textasciitilde P} \left[\text{i}\right]\right) : \\ \left(\& \text{O Mask} \left[\text{m:} \left(\text{i} + 1\right)\right] \& \text{P} \left[\text{i}\right]\right)\end{matrix}$$

Mathematical proof: Using Z Mask in place of computation of the OR of the sum. Theorem: S[k] = 0 for all k in interval n ≥ k ≥ i, if and only if Z Mask[k] = 0 in the interval n ≥ k > i and S[i] = 0. Proof: Suppose S[k] = 0 for all k in the interval n ≥ k ≥ i but Z Mask[m] = 1 for an index m in the interval n ≥ m > i. Now Z Mask[m] = 1 implies P[m] is equal to Z[m-1]. If P[m] then Z[m-1] makes S[m]=1. If ~P[m] then G[m-1] makes S[m]=1, while P[m-1] makes either S[m] = 1 (if there is carry) or S[m-1] = 1 (if there isn’t carry). So, we have Z Mask[m] = 0.

The opposite proof. Suppose that Z Mask[k] = 0 for n ≥ k > i and S[i] = 0, but S[m] = 1 for an index m in interval n ≥ m > i. Suppose m is lowest bit index for which S[m] = 0, i.e. S[k] = 1 for all k in interval m > k ≥ i. Z Mask[m] = 0 implies P[m] is opposite to Z[m-1]. If P[m] then G[m-1] is impossible because then S[m] = 0, while P[m-1] makes either S[m] = 0 (if there is carry) or S[m-1] = 1 (if there isn’t carry) which contradicts the initial assumption of minimal m. If ~P[m] then Z[m-1] makes S[m] = 0. So, we have Z Mask[m] = 1. It is sufficient to compute |Z Mask[m: (i + 1)] | S[i] to get the OR of the sum (i.e., |S[m:i]).

$$\vert \text{S} \left[\text{m: i}\right] = \vert \text{Z Mask} \left[\text{m:} \left(\text{i} + 1\right)\right] \vert \text{S} \left[\text{i}\right]$$

$$\text{S} \left[\text{i}\right] = \text{C} \left[\text{i}\right] ? \text{\textasciitilde P} \left[\text{i}\right] : \text{P} \left[\text{i}\right]$$

$$\begin{matrix}\vert \text{S} \left[\text{m: i}\right] = \text{C} \left[\text{i}\right] ? \left(\vert \text{Z Mask} \left[\text{m:} \left(\text{i} + 1\right)\right] \vert \text{\textasciitilde P} \left[\text{i}\right]\right) : \\ \left(\vert \text{Z Mask} \left[\text{m:} \left(\text{i} + 1\right)\right] \vert \text{P} \left[\text{i}\right]\right)\end{matrix}$$

In an embodiment, the O mask 208 and the Z mask 224 may be generated using one stage XOR/XNOR gates from P and G. These AND/OR chains can be computed faster than an adder carry using three-input AND/OR gates, as shown in FIG. 2. As n ≥ i, C[i] will be faster than C[n], at worst case, it they will be produced at same time, so the AND of the sum and the OR of the sum computation using this mask technique is faster than S[n], or at worst case, the same as the adder delay.

The i^{th}_increment is defined as adding 1 at an intermediate bit i of an adder. In other words, it is adding 2^i to the adder result.

$${i}^{t h} \_ i n c r e m e n t = {\left\{{S}_{i n c} \left[k\right]\right\}}_{k = 0}^{n} = S \left[n : 0\right] + {2}^{i} = X \left[n : 0\right] + Y \left[n : 0\right] + {2}^{i}$$

Table 2 shows the i^{th}_increment.

| | | | | | | | | | | | | |
|---|---|---|---|---|---|---|---|---|---|---|---|---|
| | n | . | . | m | . | k | . | i | . | . | 1 | 0 |
| X[n:0] | X[n] | | | X[m] | | X[k] | | X[i] | | | X[1] | X[0] |
| Y[n:0] | Y[n] | | | Y[m] | | Y[k] | | Y[i] | | | Y[1] | Y[0] |
| S[n:0] | S[n] | . | . | S[m] | . | S[k] | | S[i] | . | . | S[1] | S[0] |
| (+2ⁱ) | 0 | 0 | 0 | 0 | 0 | 0 | 0 | 1 | 0 | 0 | 0 | 0 |
| S_{inc} [n:0] | S_{inc} [n] | | | S_{inc} [m] | | S_{inc} [k] | | S_{inc} [i] | | | S_{inc} [1] | S_{inc} [0] |

As shown in Table 2, there is no addition for right side of bit i (i.e., [(i-1):0]) so it will same as the original sum S.

$${S}_{i n c} \left[\left(i - 1\right) : 0\right] = S \left[\left(i - 1\right) : 0\right]$$

For bit i, S is added with a 1, so:

$${S}_{{}^{i n c}} \left[i\right] = S \left[i\right] ⊕ 1 = \sim S \left[i\right]$$

Then [i:0] can be extracted from the sum S without any computation. For the upper part, the left of i can expressed as:

$${S}_{i n c} \left[n : \left(i + 1\right)\right] = S \left[n : \left(i + 1\right)\right] ⊕ 0 ⊕ {C}_{i n c} \left[n : \left(i + 1\right)\right]$$

$$= S \left[n : \left(i + 1\right)\right] ⊕ {C}_{i n c} \left[n : \left(i + 1\right)\right]$$

$$\text{Now,} {C}_{i n c} \left[i + 1\right] = S \left[i\right] \& 1 = S \left[i\right]$$

$${C}_{i n c} \left[i + 2\right] = S \left[i + 1\right] \& {C}_{i n c} \left[i + 1\right] = S \left[i + 1\right] \& S \left[i\right] = \& S \left[\left(i + 1\right) : i\right]$$

By mathematical induction, it can be proved for any bit k in the interval n ≥ k > i:

$${C}_{i n c} \left[k\right] = \& S \left[\left(k - 1\right) : i\right]$$

This is the AND of the sum and may be computed using 0 Mask in parallel with operation of the adder:

$${C}_{i n c} \left[k\right] = \& O M a s k \left[\left(k - 1\right) : \left(i + 1\right)\right] \& S \left[i\right]$$

$$\begin{matrix}{C}_{i n c} \left[k\right] = C \left[i\right] ? \& 0 M a s k \left[\left(k - 1\right) : \left(i + 1\right)\right] \& \sim P \left[i\right] : \\ \& 0 M a s k \left[\left(k - 1\right) : \left(i + 1\right)\right] \& P \left[i\right]\end{matrix}$$

The value C_{inc} can be computed with the same delay as operation of the adder and S_{inc} with one more XOR delay, which is one XOR delay faster than an existing parallel design. The hardware requirement is very close to what a serial design requires for an adder and the AND chain for an increment followed by XOR for final S_{inc}; the mask XOR is extra hardware that adds a negligible amount to the overall hardware requirements for this computation.

The i^{th}_decrement’ is defined as subtracting 1 at an intermediate bit i of an adder. In other words, it is subtracting 2^i from the adder result.

$${i}^{t h} \_ d e c r e m e n t = {\left\{{S}_{d e c} \left[k\right]\right\}}_{k = 0}^{n} = X \left[n : 0\right] + Y \left[n : 0\right] - {2}^{i}$$

Table 3 shows the i^{th}_decrement.

| | | | | | | | | | | | | |
|---|---|---|---|---|---|---|---|---|---|---|---|---|
| | n | . | . | m | . | k | . | i | . | . | 1 | 0 |
| X[n:0] | X[n] | | | X[m] | | X[k] | | X[i] | | | X[1] | X[0] |
| Y[n:0] | Y[n] | | | Y[m] | | Y[k] | | Y[i] | | | Y[1] | Y[0] |
| S[n:0] | S[n] | . | . | S[m] | . | S[k] | . | S[i] | . | . | S[1] | S[0] |
| (-2ⁱ) | 1 | 1 | 1 | 1 | 1 | 1 | 1 | 1 | 0 | 0 | 0 | 0 |
| S_{dec} [n:0] | S_{dec} [n] | | | S_{dec} [m] | | S_{dec} [k] | | S_{dec} [i] | | | S_{dec}[1] | S_{dec} [0] |

Like the increment operation, there is no addition for the right side of bit i (i.e., [(i-1):0]), so it will be the same as the original sum S:

$${S}_{d e c} \left[\left(i - 1\right) : 0\right] = S \left[\left(i - 1\right) : 0\right]$$

For bit i, the sum S is added with 1, so:

$${S}_{d e c} \left[i\right] = S \left[i\right] ⊕ 1 = \sim S \left[i\right]$$

$$\begin{matrix}{S}_{d e c} \left[n : i\right] = S \left[n : i\right] ⊕ 1 ⊕ {C}_{d e c} \left[n : i\right] = \\ \sim S \left[n : i\right] ⊕ {C}_{d e c} \left[n : i\right]\end{matrix}$$

$$N o w , {C}_{d e c} \left[i + 1\right] = S \left[i\right] \& 1 = S \left[i\right]$$

$${C}_{i n c} \left[i + 2\right] = S \left[i + 1\right] \left|{C}_{d e c} \left[i + 1\right] = S \left[i + 1\right] \left|S \left[i\right] = \left|S \left[\left(i + 1\right) : i\right]\right)\right)\right)$$

By mathematical induction, it can be proved for any bit k in the interval n ≥ k > i:

$${C}_{d e c} \left[k\right] = \left|S \left[\left(k - 1\right) : i\right]\right)$$

This is the OR of Sum and can be computed using Z Mask 224 in parallel to operation of the adder:

$${C}_{d e c} \left[k\right] = \left|S \left[\left(k - 1\right) : i\right]\right) = \left|Z M a s k \left[\left(k - 1\right) : \left(i + 1\right)\right]\right| S \left[i\right]$$

$$\begin{matrix}{C}_{d e c} \left[k\right] = C \left[i\right] ? \left(\left|Z M a s k \left[\left(k - 1\right) : \left(i + 1\right)\right]\right| \sim P \left[i\right]\right) : \\ \left(\left|Z M a s k \left[\left(k - 1\right) : \left(i + 1\right)\right]\right| P \left[i\right]\right)\end{matrix}$$

Another operation that may result in increased performance from embodiments is a limit check. A limit check of the result of the addition/subtraction of two input operands X[n:0] and Y[n:0] being less than a limit 2^i (i.e., abs({Cout, S[n:0]}) < 2ⁱ). For an unsigned number, it is sufficient to check any 1 to the left side of bit i of the result, which is |S[n:i]| Cout, which may be calculated in parallel to the addition/subtraction operation using the Z Mask 224 in the same way described above. For a signed number, the result can be positive or negative. For a positive number, this is the same as for the unsigned number limit check. For a negative number, check any ‘0’ in the left of bit ‘i’ which may be calculated in parallel to addition/subtraction using O mask 208 as shown above.

Another operation that may result in increased performance from embodiments is an absolute sum or difference. In this case, an absolute value of the result of addition or subtraction of two input operands X[n:0] and Y[n:0] is computed as:

$$S u m = {\left\{S \left[k\right]\right\}}_{k = 0}^{n} = X \pm Y$$

$$\begin{matrix}- S u m = - \left(X \pm Y\right) = - \left(X \pm Y - 1\right) - 1 = \sim \left(X \pm Y - 1\right) = \\ \left\{\sim {S}_{d e c} \left[k\right]\right\} {}_{k = 0}^{n}\end{matrix}$$

$$a b s \left(s u m\right) = \left|S u m\right| = N e g ? \left\{\sim {S}_{d e c} \left[k\right]\right\} {}_{k = 0}^{n} : \left\{S \left[k\right]\right\} {}_{k = 0}^{n}$$

Another that may result in increased performance from embodiments is rounding of a floating-point sum. At the last stage of computing a floating-point sum, there are two mantissas X[n:0], Y[n:0] and an integer sum of the aligned mantissas may be computed as:

$$X \left[n : 0\right] + \left\{\left(m z e r o s\right) , Y \left[n : n \text{-} m\right]\right\}$$

The tail Y[n-m-1:0] defines rounding (i.e., a possible addition of 1 to the sum), which may be considered as a carry-in to the sum S. The j-bit (the highest bit 1 of the result) may take the positions: n or n+1. In the last case, 1 should be added to bit [1] instead of [0]. If 1 is always added to bit [1], the technique described above may be used to perform the rounding in parallel with addition of the [0079]. When the sum S is calculated and the j-bit position is known, one of the calculated sums is selected. In this way rounding is performed faster and uses only a small amount of additional hardware. In the case of rounding at several sizes at once (for example, single, double and half accuracy) it is necessity to add 1 at several bit locations. The described technique also works well for this case and produces two results for selection in parallel and with minimal additional hardware.

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a central processing unit (CPU) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 4B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, microcode entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general-purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster - and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch unit 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

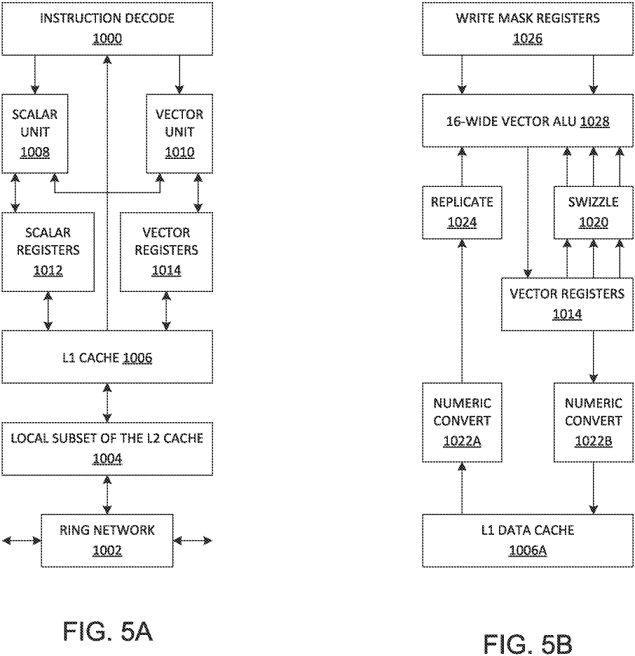

FIGS. 5A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 5A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 5B is an expanded view of part of the processor core in FIG. 5A according to embodiments of the invention. FIG. 5B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

FIG. 6 is a block diagram of a processor 1100 that may have more than one core, may have an integrated memory controller, and may have integrated graphics according to embodiments of the invention. The solid lined boxes in FIG. 6 illustrate a processor 1100 with a single core 1102A, a system agent unit 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring-based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

### Exemplary Computer Architectures

FIGS. 7-10 are block diagrams of exemplary computer architectures in which embodiments may be implemented. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 7, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 7 with broken lines. Each processor 1210, 1215 may include one or more of the processing cores described herein and may be some version of the processor 1100.

The memory 1240 may be, for example, dynamic random-access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 8, shown is a block diagram of a first more specific exemplary system 1300 in accordance with an embodiment of the present invention. As shown in FIG. 8, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller unit point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 8, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors yet connected with the processors via P-P interconnect, such that either or both processors’ local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 8, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU’s, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 8, a system may implement a multi-drop bus or other such architecture.

Referring now to FIG. 9, shown is a block diagram of a second more specific exemplary system 1400 in accordance with an embodiment of the present invention. Like elements in FIGS. 8 and 9 bear like reference numerals, and certain aspects of FIG. 8 have been omitted from FIG. 9 in order to avoid obscuring other aspects of FIG. 9.

FIG. 9 illustrates that the processors 1370, 1380 may include integrated memory and I/O control logic (“CL”) 1472 and 1482, respectively. Thus, the CL 1472, 1482 include integrated memory controller units and include I/O control logic. FIG. 9 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

Referring now to FIG. 10, shown is a block diagram of a SoC 1500 in accordance with an embodiment of the present invention. Similar elements in FIG. 10 bear like reference numerals. Also, dashed lined boxes are optional features on more advanced SoCs. In FIG. 10, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 8, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable’s (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 11 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 11 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 11 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, CA and/or that execute the ARM instruction set of ARM Holdings of Sunnyvale, CA). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Techniques and architectures for a processor or core with interrupt expansion features are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

The following examples pertain to further embodiments. Example 1 is an apparatus including a first mask to receive a first input operand and a second input operand and to generate a selected portion of an AND of a sum of the first input operand and the second input operand using an AND chain of the first mask in parallel with generation of the sum by an adder; and a second mask to receive the first input operand and the second input operand and to generate the selected portion of an OR of the sum using an OR chain of the second mask in parallel with generation of the sum.

In Example 2, the subject matter of Example 1 can optionally include the first mask to generate an increment of any portion of the sum using an AND chain of the first mask in parallel with generation of the sum.

In Example 3, the subject matter of Example 1 can optionally include the second mask to generate a decrement of any portion of the sum using an OR chain of the second mask in parallel with generation of the sum.

In Example 4, the subject matter of Example 1 can optionally include wherein the first mask is defined by

$$F i r s t M a s k \left[k\right] {=}^{\text{def}} P \left[k\right] ⊕ G \left[k - 1\right] f o r n \geq k > i$$

where G[k] is generation and P[k] is propagation of an adder at bit position ‘k’ which is computed from the first input operand denoted X[n:0] and the second input operand denoted Y[n:0] as G [k] = X[k] & Y[k] and P[k] = X[k] ⊕ Y[k]. In Example 5, the subject matter of Example 1 can optionally include wherein the first mask is defined by

$$F i r s t M a s k \left[k\right] = X \left[k\right] ⊕ Y \left[k\right] ⊕ \left(X \left[k - 1\right] \& Y \left[k - 1\right]\right)$$

wherein the first input operand is denoted X[n:0], the second input operand is denoted Y[n:0], and ‘k’ is a bit position of an adder. In Example 6, the subject matter of Example 1 can optionally include wherein the second mask is defined by

$$S e c o n d M a s k \left[k\right] {=}^{\text{def}} P \left[k\right] ⊙ Z \left[k - 1\right] f o r \text{n} \geq \text{k} > \text{i}$$

where Z[k] is zero and P[k] is propagation of an adder at bit position ‘k’ which is computed from the first input operand denoted X[n:0] and the second input operand denoted Y[n:0] as Z[k] = ~(X[k] | Y[k]) and P[k] = X[k] ⊕ Y[k]. In Example 7, the subject matter of Example 1 can optionally include wherein the second mask is defined by

$$S e c o n d M a s k \left[k\right] = X \left[k\right] ⊕ Y \left[k\right] ⊕ \left(X \left[k - 1\right] \left|Y\right) \left[k - 1\right]\right)$$

wherein the first input operand is denoted X[n:0], the second input operand is denoted Y[n:0], and ‘k’ is a bit position of an adder.

In Example 8, the subject matter of Example 1 can optionally include generating the selected portion of the OR of the sum of the first input operand and the second input operand in parallel with a carry chain of the adder at a lesser delay than the carry chain.

In Example 9, the subject matter of Example 1 can optionally include generating the selected portion of the OR of the sum of the first input operand and the second input operand in parallel with a carry chain of the adder at a lesser delay than the carry chain.

Example 10 is a method including at least one of generating a first mask from a first input operand and a second input operand and performing an AND chain of the first mask in parallel with computing a sum of the first and second input operands to generate an AND of selected bits of the sum; and generating a second mask from the first and second input operand and performing an OR chain of the second mask in parallel with computation of the sum to generate an OR of selected bits of the sum.

In Example 11, the subject matter of Example 10 can optionally include the first mask generating an increment of any portion of the sum using an AND chain of the first mask in parallel with generation of the sum.

In Example 12, the subject matter of Example 10 can optionally include the second mask generating a decrement of any portion of the sum using an OR chain of the second mask in parallel with generation of the sum.

In Example 13, the subject matter of Example 10 can optionally include wherein the first mask is defined by

$$F i r s t M a s k \left[k\right] {=}^{\text{def}} P \left[k\right] ⊕ G \left[k - 1\right] f o r \text{n} \geq \text{k} > i$$

where G[k] is generation and P[k] is propagation of an adder at bit position ‘k’ which is computed from the first input operand denoted X[n:0] and the second input operand denoted Y[n:0] as G[k] = X[k] & Y[k] and P[k] = X[k] ⊕ Y[k]. In Example 14, the subject matter of Example 10 can optionally include wherein the first mask is defined by

$$F i r s t M a s k \left[k\right] = X \left[k\right] ⊕ Y \left[k\right] ⊕ \left(X \left[k - 1\right] \& Y \left[k - 1\right]\right)$$

wherein the first input operand is denoted X[n:0], the second input operand is denoted Y[n:0], and ‘k’ is a bit position of an adder. In Example 15, the subject matter of Example 10 can optionally include wherein the second mask is defined by

$$S e c o n d M a s k \left[k\right] {=}^{\text{def}} P \left[k\right] ⊙ Z \left[k - 1\right] f o r \text{n} \geq \text{k} > i$$

where Z[k] is zero and P[k] is propagation of an adder at bit position ‘k’ which is computed from the first input operand denoted X[n:0] and the second input operand denoted Y[n:0] as Z[k] = ~(X[k] | Y[k]) and P[k] = X[k] ⊕ Y[k]. In Example 16, the subject matter of Example 10 can optionally include wherein the second mask is defined by

$$S e c o n d M a s k \left[k\right] = X \left[k\right] ⊕ Y \left[k\right] ⊕ \left(X \left[k - 1\right] \left|Y\right) \left[k - 1\right]\right)$$

wherein the first input operand is denoted X[n:0], the second input operand is denoted Y[n:0], and ‘k’ is a bit position of an adder.

In Example 17, the subject matter of Example 10 can optionally include generating the selected portion of the OR of the sum of the first input operand and the second input operand in parallel with a carry chain of an adder at a lesser delay than the carry chain.

In Example 18, the subject matter of Example 10 can optionally include generating the selected portion of the AND of the sum of the first input operand and the second input operand in parallel with a carry chain of an adder at a lesser delay than the carry chain.

Example 19 is a system including a memory to store a first input operand and a second input operand; and a processor, coupled to the memory, including an adder; a first mask to receive the first input operand and the second input operand and to generate a selected portion of an AND of a sum of the first input operand and the second input operand using an AND chain of the first mask in parallel with generation of the sum by the adder; and a second mask to receive the first input operand and the second input operand and to generate the selected portion of an OR of the sum using an OR chain of the second mask in parallel with generation of the sum.

In Example 20, the subject matter of Example 19 can optionally include the first mask to generate an increment of any portion of the sum using an AND chain of the first mask in parallel with generation of the sum.

In Example 21, the subject matter of Example 19 can optionally include the second mask to generate a decrement of any portion of the sum using an OR chain of the second mask in parallel with generation of the sum.

In Example 22, the subject matter of Example 19 can optionally include wherein the first mask is defined by

$$F i r s t M a s k \left[k\right] {=}^{\text{def}} P \left[k\right] ⊕ G \left[k - 1\right] f o r \text{n} \geq \text{k} > i$$

where G[k] is generation and P[k] is propagation of the adder at bit position ‘k’ which is computed from the first input operand denoted X[n:0] and the second input operand denoted Y[n:0] as G[k] = X[k] & Y[k] and P[k] = X[k] ⊕ Y[k]. In Example 23, the subject matter of Example 19 can optionally include wherein the second mask is defined by

$$S e c o n d M a s k \left[k\right] {=}^{\text{def}} P \left[k\right] ⊙ Z \left[k - 1\right] f o r \text{n} \geq \text{k} > i$$

where Z[k] is zero and P[k] is propagation of the adder at bit position ‘k’ which is computed from the first input operand denoted X[n:0] and the second input operand denoted Y[n:0] as Z[k] = ~(X[k] | Y[k]) and P[k] = X[k] ⊕ Y[k].

Example 24 provides an apparatus comprising means for performing the method of any one of Examples 10-17.

Example 25 comprises the subject matter of Example 24 and the means for performing the method comprises a processor and at least one memory.

Example 26 comprises the subject matter of Example 25 and the at least one memory comprises machine readable instructions that when executed, cause the apparatus to perform the method of any one of Examples 10-17.

Example 27 comprises the subject matter of any one of Examples 1-9 and the apparatus is one of a computing system or a system-on-a-chip.

References herein to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions and coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

The specification and drawings are, accordingly, to be regarded in an illustrative rather than a restrictive sense. Those skilled in the art will appreciate that the broad techniques of the embodiments described herein can be implemented in a variety of forms. Therefore, while the embodiments have been described in connection with examples thereof, the true scope of the embodiments should not be so limited since other modifications will become apparent to the skilled practitioner upon a study of the drawings, specification, and following claims.

What is claimed is:

1. An apparatus comprising:
at least one of
a first mask to receive a first input operand and a second input operand and to generate a selected portion of an AND of a sum of the first input operand and the second input operand using an AND chain of the first mask in parallel with generation of the sum by an adder; and
a second mask to receive the first input operand and the second input operand and to generate the selected portion of an OR of the sum using an OR chain of the second mask in parallel with generation of the sum.

2. The apparatus of claim 1, the first mask to generate an increment of any portion of the sum using an AND chain of the first mask in parallel with generation of the sum.

3. The apparatus of claim 1, the second mask to generate a decrement of any portion of the sum using an OR chain of the second mask in parallel with generation of the sum.

4. The apparatus of claim 1, wherein the first mask is defined by
$$F i r s t M a s k \left[k\right] {}^{\underline{\underline{\text{def}}}} P \left[k\right] ⊕ G \left[k - 1\right] f o r \text{n} \geq \text{k} > i$$
where G[k] is generation and P[k] is propagation of an adder at bit position ‘k’ which is computed from the first input operand denoted X[n:0] and the second input operand denoted Y[n:0] as G[k] = X[k] & Y[k] and P[k] = X[k] ⊕ Y[k].

5. The apparatus of claim 1, wherein the first mask is defined by
$$F i r s t M a s k \left[k\right] = X \left[k\right] ⊕ Y \left[k\right] ⊕ \left(X \left[k - 1\right] \& Y \left[k - 1\right]\right)$$
wherein the first input operand is denoted X[n:0], the second input operand is denoted Y[n:0], and ‘k’ is a bit position of an adder.

6. The apparatus of claim 1, wherein the second mask is defined by
$$S e c o n d M a s k \left[k\right] {}^{\underline{\underline{\text{def}}}} P \left[k\right] ⊙ Z \left[k - 1\right] f o r \text{n} \geq \text{k} > i$$
where Z[k] is zero and P[k] is propagation of an adder at bit position ‘k’ which is computed from the first input operand denoted X[n:0] and the second input operand denoted Y[n:0] as Z[k] = ~(X[k] | Y[k]) and P[k] = X[k] ⊕ Y[k].

7. The apparatus of claim 1, wherein the second mask is defined by
$$S e c o n d M a s k \left[k\right] = X \left[k\right] ⊕ Y \left[k\right] ⊕ \left(X \left[k - 1\right] \vert Y \left[k - 1\right]\right)$$
wherein the first input operand is denoted X[n:0], the second input operand is denoted Y[n:0], and ‘k’ is a bit position of an adder.

8. The apparatus of claim 1, comprising generating the selected portion of the OR of the sum of the first input operand and the second input operand in parallel with a carry chain of the adder at a lesser delay than the carry chain.

9. The apparatus of claim 1, comprising generating the selected portion of the AND of the sum of the first input operand and the second input operand in parallel with a carry chain of the adder at a lesser delay than the carry chain.

10. A method comprising:
at least one of
generating a first mask from a first input operand and a second input operand and performing an AND chain of the first mask in parallel with computing a sum of the first and second input operands to generate an AND of selected bits of the sum; and
generating a second mask from the first and second input operand
and performing an OR chain of the second mask in parallel with computation of the sum to generate an OR of selected bits of the sum.

11. The method of claim 10, comprising the first mask generating an increment of any portion of the sum using an AND chain of the first mask in parallel with generation of the sum.

12. The method of claim 10, comprising the second mask generating a decrement of any portion of the sum using an OR chain of the second mask in parallel with generation of the sum.

13. The method of claim 10, wherein the first mask is defined by
$$F i r s t M a s k \left[k\right] {=}^{{}^{\text{def}}} P \left[k\right] ⊕ G \left[k - 1\right] f o r \text{n} \geq \text{k} > i$$
where G[k] is generation and P[k] is propagation of an adder at bit position ‘k’ which is computed from the first input operand denoted X[n:0] and the second input operand denoted Y[n:0] as G[k] = ~(X[k] & Y[k] and P[k] = X[k] ⊕ Y[k].

14. The method of claim 10, wherein the first mask is defined by
$$F i r s t M a s k \left[k\right] = X \left[k\right] ⊕ Y \left[k\right] ⊕ \left(X \left[k - 1\right] \& Y \left[k - 1\right]\right)$$
wherein the first input operand is denoted X[n:0], the second input operand is denoted Y[n:0], and ‘k’ is a bit position of an adder.

15. The method of claim 10, wherein the second mask is defined by
$$S e c o n d M a s k \left[k\right] {=}^{{}^{\text{def}}} P \left[k\right] ⊙ Z \left[k - 1\right] f o r \text{n} \geq \text{k} > i$$
where Z[k] is zero and P[k] is propagation of an adder at bit position ‘k’ which is computed from the first input operand denoted X[n:0] and the second input operand denoted Y[n:0] as Z[k] = ~(X[k] | Y[k]) and P[k] = X[k] ⊕ Y[k].

16. The method of claim 10, wherein the second mask is defined by
$$S e c o n d M a s k \left[k\right] = X \left[k\right] ⊕ Y \left[k\right] ⊕ \left(X \left[k - 1\right] \vert Y \left[k - 1\right]\right)$$
wherein the first input operand is denoted X[n:0], the second input operand is denoted Y[n:0], and ‘k’ is a bit position of an adder.

17. The method of claim 10, comprising generating a selected portion of the OR of the sum of the first input operand and the second input operand in parallel with a carry chain of an adder at a lesser delay than the carry chain.

18. The method of claim 10, comprising generating a selected portion of the AND of the sum of the first input operand and the second input operand in parallel with a carry chain of an adder at a lesser delay than the carry chain.

19. A system comprising:
a memory to store a first input operand and a second input operand; and
a processor, coupled to the memory, including
an adder;
at least one of
a first mask to receive the first input operand and the second input operand and to generate a selected portion of an AND of a sum of the first input operand and the second input operand using an AND chain of the first mask in parallel with generation of the sum by the adder; and
a second mask to receive the first input operand and the second input operand and to generate the selected portion of an OR of the sum using an OR chain of the second mask in parallel with generation of the sum.

20. The system of claim 19, the first mask to generate an increment of any portion of the sum using an AND chain of the first mask in parallel with generation of the sum.

21. The system of claim 19, the second mask to generate a decrement of any portion of the sum using an OR chain of the second mask in parallel with generation of the sum.

22. The system of claim 19, wherein the first mask is defined by
$$F i r s t M a s k \left[k\right] {}^{\underline{\underline{\text{def}}}} P \left[k\right] ⊕ G \left[k - 1\right] f o r \text{n} \geq \text{k} > i$$
where G[k] is generation and P[k] is propagation of the adder at bit position ‘k’ which is computed from the first input operand denoted X[n:0] and the second input operand denoted Y[n:0] as G[k] = X[k] & Y[k] and P[k] = X[k] ⊕ Y[k].

23. The system of claim 19, wherein the second mask is defined by
$$S e c o n d M a s k \left[k\right] {}^{\underline{\underline{\text{def}}}} P \left[k\right] ⊙ Z \left[k - 1\right] f o r \text{n} \geq \text{k} > i$$
where Z[k] is zero and P[k] is propagation of the adder at bit position ‘k’ which is computed from the first input operand denoted X[n:0] and the second input operand denoted Y[n:0] as Z[k] = ~(X[k] | Y[k]) and P[k] = X[k] ⊕ Y[k].
